(19) United States
(12) Patent Application Publication
(10) Pub. No.: US 2025/0187997 A1
(43) Pub. Date: Jun. 12, 2025

(54) MULTISTAGE RECYCLING METHOD OF MAGNESIUM MODIFIED CARBON-BASED PHOSPHORUS ADSORBENT WASTE

(71) Applicant: Jiangsu Academy of Agricultural Sciences, Nanjing (CN)

(72) Inventors: Lihong XUE, Nanjing (CN); Ruiqian LIU, Nanjing (CN); Yanfang FENG, Nanjing (CN); Jianguang YU, Nanjing (CN); Linzhang YANG, Nanjing (CN)

(21) Appl. No.: 18/951,436

(22) Filed: Nov. 18, 2024

(30) Foreign Application Priority Data
Dec. 6, 2023 (CN) 202311663061.1

(51) Int. Cl. C05F 17/10

(52) U.S. Cl. CPC C05F 17/10

(57) ABSTRACT

The present invention discloses a multistage recycling method of magnesium modified carbon-based phosphorus adsorbent waste, and belongs to the technical field of application of phosphorus adsorbent. The present invention introduces the magnesium modified carbon-based phosphorus adsorbent waste into a compost material for primary recycling, thereby reducing ammonia volatilization, while immobilizing nitrogen and improving the environment of soil microbial during the composting process; and after the composting is completed, it is applied to the field with the compost material for secondary recycling, thus reducing the application of chemical fertilizers, promoting crop growth, and improving the soil fertility, and turning magnesium modified carbon-based phosphorus adsorbent waste into treasure, so that it can play a high economic and environmental effects in both stages of recycling.

### TECHNICAL FIELD

The present invention belongs to the technical field of phosphorus adsorbent application, and more specifically, relates to a multistage recycling method of magnesium modified carbon-based phosphorus adsorbent waste.

### BACKGROUND

The magnesium modified carbon-based material is a commonly used adsorption material for phosphorus removal. At present, the method for treating and recycling the phosphorus adsorption materials after its adsorption saturation is mainly to soak the saturated adsorption materials with high concentration sodium hydroxide solution, thus restoring its phosphorus adsorption function.

For example, the Chinese invention patent application No. 200610010634.0 filed Jan. 17, 2006 discloses a method for regenerating a rare earth adsorbent after removal of nitrogen and phosphorus from wastewater, where the saturated adsorbent is first subjected to a cyclic desorption with a regeneration solution, while the pH of the regeneration solution is adjusted with an alkaline solution, thus desorption is achieved, and finally impregnation is carried out to achieve the regeneration of adsorbent. For another example, the Chinese invention patent application No. 201810706605.0 filed Jul. 2, 2018 discloses a method for adsorbing and degrading nitrogen and phosphorus in domestic sewage with modified steel slag-zeolite. The phosphorus is removed by organic-inorganic composite modified steel slag particles with fixed-bed column. After adsorption saturation, it is regenerated by NaCl solution.

However, the conventional desorption and regeneration methods often significantly decrease the adsorption capacity of the materials after a certain number of cycles, thus decreasing economic benefits. This process includes multiple operations such as recovering, soaking, and re-applying, which not only requires high labor costs, but also requires reprocessing of the desorption solution. The overall cost of treating and recycling is no less than that of re-preparing the material. In summary, the methods for treating and recycling of the magnesium modified carbon-based phosphorus adsorbent waste have unsatisfactory economic and environmental benefits, which is one of the main reasons why this type of adsorbents has not been applied on a large scale.

### SUMMARY

### 1. Problems to be Solved

In view of the problems of poor recycling effect and low economic benefit of phosphorus adsorbent materials, the present invention provides a multistage recycling method of magnesium modified carbon-based phosphorus adsorbent waste. The present invention introduces magnesium modified carbon-based phosphorus adsorbent waste into compost for primary recycling, thereby reducing ammonia volatilization, while immobilizing nitrogen and improving the environment of the microbial during the composting process. After the composting is completed, it is applied to the field together with the compost material as a substitute for chemical fertilizers for secondary recycling, thus reducing the application of chemical fertilizers, promoting crop growth, and improving soil fertility.

### 2. Technical Solution

In order to solve the aforementioned problems, the technical solution adopted by the present invention is as follows.

The present invention discloses a multistage recycling method of magnesium modified carbon-based phosphorus adsorbent waste, comprising:

introducing a magnesium modified carbon-based phosphorus adsorbent waste into a compost material for primary recycling, thereby reducing ammonia volatilization, while immobilizing nitrogen and improving the environment of the microbial during the composting process.

After the composting is completed, applying the magnesium modified carbon-based phosphorus adsorbent waste to a field with the compost material as a substitute for chemical fertilizers for secondary recycling, thereby reducing the application of chemical fertilizers, promoting crop growth, and improving soil fertility.

Preferably, the magnesium modified carbon-based phosphorus adsorbent waste is introduced into the compost before the start of composting or in the early stage of composting, or before the first compost pile turning.

Preferably, the addition amount of the magnesium modified carbon-based phosphorus adsorbent waste accounts for 1-30% of a total dry weight of the compost material.

Preferably, a total carbon to nitrogen ratio of the compost material is between 20:1 and 30:1.

Preferably, in the process of introducing magnesium modified carbon-based phosphorus adsorbent waste into compost for primary recycling, a composting cycle is 20-60 days.

Preferably, after the composting is completed, the magnesium modified carbon-based phosphorus adsorbent waste is applied to the field together with the compost material in such a way as to equally replace chemical nitrogen and phosphorus with the above organic fertilizer, the amount of the above organic fertilizer applying to the field is 200-1000 kg for 667 m², and a substitution ratio of chemical nitrogen fertilizer does not exceed 50%.

Preferably, the magnesium modified carbon-based phosphorus adsorbent waste is a magnesium modified biochar adsorbent waste, where the biochar comprises carbon felts, carbon fibers, activated carbon, carbon nanotubes, carbon bricks, graphite, graphene, graphene oxide, carbon aerogel, carbon spheres, or carbon foams.

Preferably, the compost material is one or more of straw, weeds, edible fungus residue, food scraps, kitchen waste, sludge, bark, sawdust, chaff, wood ash, livestock and poultry manure, or animal hair, horns, hooves and bones.

Preferably, the substitution ratio of chemical nitrogen fertilizer applying to the field is 5-25%.

Preferably, a magnesium element accounts for 10% of a total mass of the magnesium modified carbon-based phosphorus adsorbent.

### 3. Beneficial Effects

The beneficial effects that the present invention achieves over the prior arts include:
1. A multistage recycling method of magnesium modified carbon-based phosphorus adsorbent waste of the present invention, in which utilizes the synergistic effect of magnesium-phosphorus complex formed in the adsorption process with carbon-based materials to adsorb and immobilize the ammonium ions and ammonia contained in the compost material or generated during the composting process. Compared with conventional composting, adding magnesium modified carbon-based phosphorus adsorbent waste can reduce ammonia volatilization in the composting process by more than 20% and immobilize more than 20% of nitrogen.
2. A multistage recycling method of magnesium modified carbon-based phosphorus adsorbent waste of the present invention, in which applies the magnesium modified carbon-based phosphorus adsorbent waste and compost material to the field after composting is completed, and the magnesium-phosphorus complex reacts with ammonium ions or ammonia to form a magnesium-nitrogen-phosphorus complex, which has the ability to slowly release magnesium, nitrogen and phosphorus into soil, thereby improving soil fertility and reducing the application of chemical nitrogen fertilizer. At the same time, the magnesium element can promote crop chlorophyll synthesis, enhance crop photosynthesis, and promote crop growth.
3. A multistage recycling method of magnesium modified carbon-based phosphorus adsorbent waste of the present invention, which has the advantages of simple process, and closely interlocked steps, and turns the magnesium modified carbon-based phosphorus adsorbent waste into treasure. Therefore, it can have high economic and environmental effects in two-stage recycling without secondary pollution and environmental risk concerns.

### BRIEF DESCRIPTION OF THE DRAWINGS

FIG. 1 shows the reduction ratio of ammonia volatilization during composting of different treatment groups;

FIG. 2 shows the increase ratio of total nitrogen in the compost piles after composting of different treatment groups;

FIG. 3 shows the germination index for each compost pile after composting of different treatment groups;

FIG. 4 shows the effect of different addition amounts of magnesium modified carbon-based phosphorus adsorbent waste on the reduction ratio of ammonia volatilization during composting;

FIG. 5 shows the effect of different addition amounts of magnesium modified carbon-based phosphorus adsorbent waste on the increase ratio of total nitrogen in the compost pile after composting;

FIG. 6 shows the effect of different addition amounts of magnesium modified carbon-based phosphorus adsorbent waste on the germination index of the fertilizer after composting;

FIG. 7 shows the rice yield at different ratios of organic fertilizer applied to the field.

### DETAILED DESCRIPTION OF EMBODIMENTS

The present invention is further described below in conjunction with specific examples.

A multistage recycling method of magnesium modified carbon-based phosphorus adsorbent waste of the present invention comprises the following steps.

Before the start of composting or in the early stage of composting or before the first compost pile turning, the magnesium modified carbon-based phosphorus adsorbent waste is introduced into the compost for primary recycling to reduce ammonia volatilization, immobilize nitrogen and improve the environment of microbial during the composting process, with a composting cycle of 20-60 days. After the completion of composting, the magnesium modified carbon-based phosphorus adsorbent waste is applied to the field together with the compost material for secondary recycling, in such a way as to equally replace chemical fertilizer nitrogen and phosphorus with organic manure nitrogen and phosphorus, the amount of applying to the field is 200-1000 kg for 667 m², and the substitution ratio of chemical nitrogen fertilizer does not exceed 50%, and it is preferred that the substitution ratio of chemical nitrogen fertilizer is 5-25%, so as to reduce the application of chemical fertilizers, promote crop growth, and improve soil fertility; where the magnesium element accounts for 10% of the total mass of the magnesium modified carbon-based phosphorus adsorbent, the addition amount of magnesium modified carbon-based phosphorus adsorbent waste accounts for 1-30% of the total dry weight of the compost material, and the total carbon to nitrogen ratio of the compost material is between 20:1 and 30:1.

It should be noted that the magnesium modified carbon-based phosphorus adsorbent waste is a magnesium modified biochar adsorbent waste, where the biochar comprises carbon felts, carbon fibers, activated carbon, carbon nanotubes, carbon bricks, graphite, graphene, graphene oxide, carbon aerogel, carbon spheres, or carbon foams. The compost material is one or more of straw, weeds, edible fungus residue, food scraps, kitchen waste, sludge, bark, sawdust, chaff, plant ash, livestock and poultry manure, or animal hair, horns, hooves and bones.

### Example 1

A multistage recycling method of magnesium modified carbon-based phosphorus adsorbent waste in this example comprises the following steps:
Step 1: The magnesium modified carbon felt, in which magnesium accounted for 10% of the total mass of the magnesium modified carbon felt, was taken, placed into a phosphorus-contaminated water body. After adsorption saturation, it was taken out and obtained magnesium modified carbon felt phosphorus adsorbent waste. Subsequently, the magnesium modified carbon felt phosphorus adsorbent waste was dried in an oven at 60° C., and chopped and evenly mixed with straw and chicken manure. The addition amount of the magnesium modified carbon felt phosphorus adsorbent waste accounted for 1% of the total dry weight of the compost material, and the mass ratio of straw to chicken manure was 1:1.5. The moisture content of the straw was 10%, the moisture content of the chicken manure was 10%, the total mass of the compost material was 10 kg, and the carbon to nitrogen ratio was 25:1.
Step 2: The compost material was crushed with a crusher, and the moisture content of the compost material was determined to be about 10% after crushing. 6 L of pure water was added to the compost material to make the moisture content of the compost material reach 65%. The compost material was transferred to a box for composting. The box dimensions were: 52.5 cm (inner diameter)×40 cm×29 cm.
Step 3: The first compost pile turning was carried out at the end of the high temperature period, during which the temperature exceeded 55° C. When the compost pile was turned, pure water was added to adjust the moisture content to 60%. In the later period, the compost pile was turned every three days without adjusting the moisture content. The composting cycle was 28 days.
Step 4: The daily temperature and ammonia volatilization during the composting process, and total nitrogen content in the compost pile before and at the end of composting were determined.
Step 5: The composted material was used as organic fertilizer to incubate radish seeds. The radish seeds were placed in a Petri dish, and the germination index was measured after 48 h of incubation at 25° C. in a light incubator.

### Comparative Example 1

This comparative example was performed in the same manner as in Example 1, except that the multistage recycling method of magnesium modified carbon-based phosphorus adsorbent waste in this comparative example comprised the following steps: Step 1, only straw and chicken manure were taken and evenly mixed at a ratio of 1:1.5, where the total mass of the compost material was 10 kg, and the carbon to nitrogen ratio was 25:1. Steps 2 to 5 above were repeated.

### Comparative Example 2

This comparative example was performed in the same manner as in Example 1, except that the multistage recycling method of magnesium modified carbon-based phosphorus adsorbent waste in this comparative example comprised the following steps: Step 1, the unmodified carbon felt was taken and evenly mixed with straw and chicken manure, where the addition amount of biochar accounted for 1% of the total dry weight of the compost material, the ratio of straw to chicken manure was 1:1.5, the total mass of the compost material was 10 kg, and the carbon to nitrogen ratio was 25:1. Steps 2 to 5 above were repeated.

### Comparative Example 3

This comparative example was performed in the same manner as in Example 1, except that the multistage recycling method of magnesium modified carbon-based phosphorus adsorbent waste in this comparative example comprised the following steps: Step 1, magnesium oxide was taken and placed into a phosphorus-contaminated water body. After adsorption saturation with phosphorus, a magnesium-phosphorus complex was obtained after filtering and drying, and evenly mixed with straw and chicken manure, where the addition amount of magnesium-phosphorus complex accounted for 0.2% of the total dry weight of the compost material, the ratio of straw to chicken manure was 1:1.5, the total mass of the compost material was 10 kg, and the carbon to nitrogen ratio was 25:1. Steps 2 to 5 above were repeated.

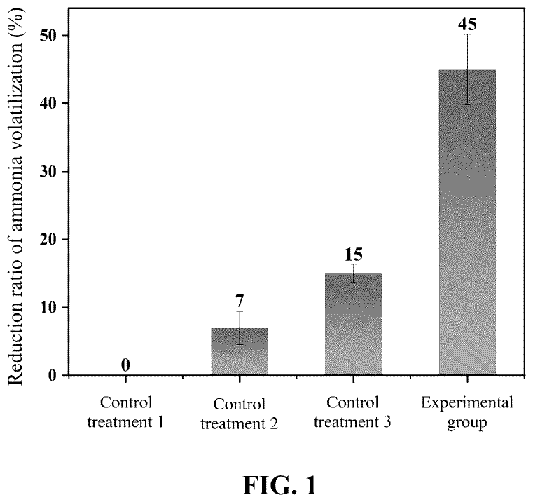

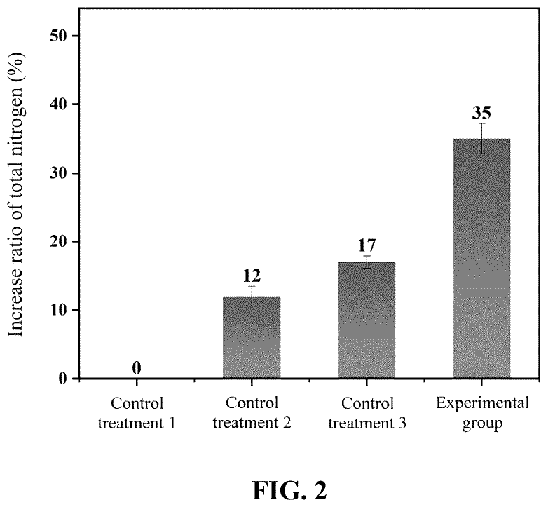

FIG. 1 shows the reduction ratio of ammonia volatilization during composting. FIG. 2 shows the increase ratio of total nitrogen in the compost pile after the completion of composting. The reduction ratio of ammonia volatilization and the increase ratio of total nitrogen are calculated as following formulas 1 and 2:

Reduction ratio of ammonia volatilization of a treatment group=1-total amount of ammonia volatilization of the treatment group/total amount of ammonia volatilization of control treatment 1 (conventional composting)×100% formula 1:

Increase ratio of total nitrogen of a treatment group=1-total nitrogen content of the treatment group/total nitrogen content of control treatment 1 (conventional composting)×100% formula 2:

The results of ammonia volatilization reduction, total nitrogen increase and germination index of Comparative examples 1, 2, and 3 and Example 1 are shown in FIGS. 1-3. As can be seen from FIGS. 1 and 2, compared with Control treatment 1 (conventional composting), the addition of magnesium modified carbon felt phosphorus adsorbent waste significantly reduces ammonia volatilization during the composting process, with an ammonia volatilization reduction of nearly 45%. After the completion of composting, the nitrogen immobilization efficiency also increases significantly, and the total nitrogen content in the compost pile increases by 35%. Compared with Control treatment 1 (conventional composting), Control treatment 2 (with carbon felt added) shows less ammonia volatilization reduction of only 7% and total nitrogen increase of only 12%. This may be because the adsorption of ammonia by pure carbon felt is relatively short-term, and the ammonia will escape again after a short period of adsorption, so the nitrogen cannot be immobilized for a long time.

Compared with Control treatment 1 (conventional composting), Control treatment 3 (with magnesium-phosphorus complex added) shows ammonia volatilization reduction of about 15% and total nitrogen increase of 17%. The overall effect of Control treatment 3 is better than that of Control treatment 2 (with carbon felt added). And due to the ligand exchange effect of magnesium-phosphorus complex on ammonia and ammonium ions, the nitrogen can be immobilized for a long time. However, compared with the treatment by the addition of magnesium modified carbon felt phosphorus adsorbent waste, the ammonia volatilization reduction and nitrogen immobilization effects vary widely. This is mainly because, although magnesium-phosphorus complex can immobilize ammonia for a long time, ammonia volatilizes quickly, and this binding process takes time. The pure magnesium-phosphorus complex has a small specific surface area and can only immobilize a small amount of ammonia, which limits its adsorption capacity of ammonia. For the magnesium modified carbon felt phosphorus adsorbent waste, the magnesium-phosphorus complex is loaded on the surface of the carbon felt, and the magnesium-phosphorus complex can convert the ammonia adsorbed by the carbon felt in a short time into long-term immobilized nitrogen, which cleverly integrates the advantages of both to achieve a synergistic coupling effect.

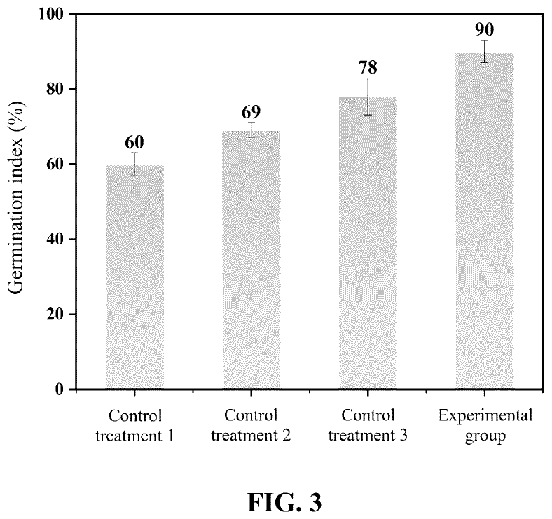

FIG. 3 shows the germination index of radish seeds cultured using the aforementioned fertilizers. The germination indices of Control treatments 1, 2 and 3 are 60%, 69% and 78% respectively, while the germination index of radish seeds treated with fertilizers having the magnesium modified carbon felt phosphorus adsorbent waste added is greatly improved, with the germination index of up to 90%. This result is benefited from superimposed effect of larger nitrogen immobilization capacity and the magnesium element.

### Example 2

This example investigated the effect of the addition amount of magnesium modified carbon-based phosphorus adsorbent waste on ammonia volatilization reduction.
Step 1: The magnesium modified biochar, in which the magnesium content accounted for 10% of the total mass of the magnesium modified biochar, was taken and placed into a phosphorus-contaminated water body, and was taken out after adsorption saturation. The magnesium modified carbon felt phosphorus adsorbent waste was dried in an oven at 60° C., and then mixed with straw and chicken manure. The addition amounts of phosphorus adsorbent waste accounted for 0%, 5%, 15%, 30% and 45% of the total dry weight of the material, and were named Blank control, Experimental groups 1, 2, 3 and 4 respectively.
Step 2: Steps 2 to 5 in Example 1 were repeated.

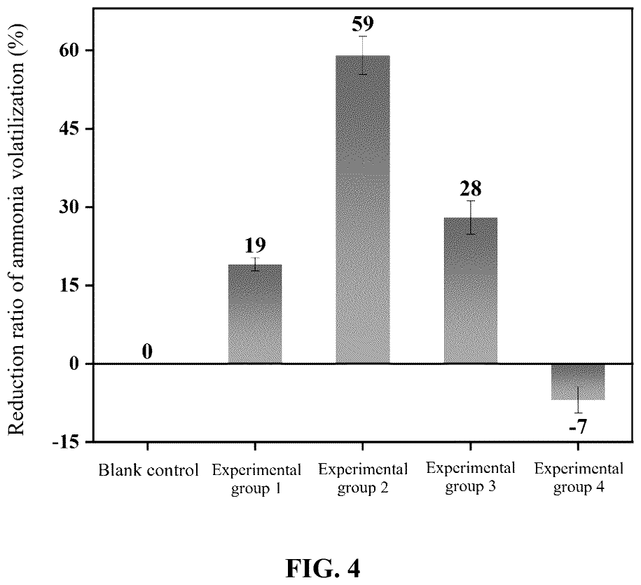

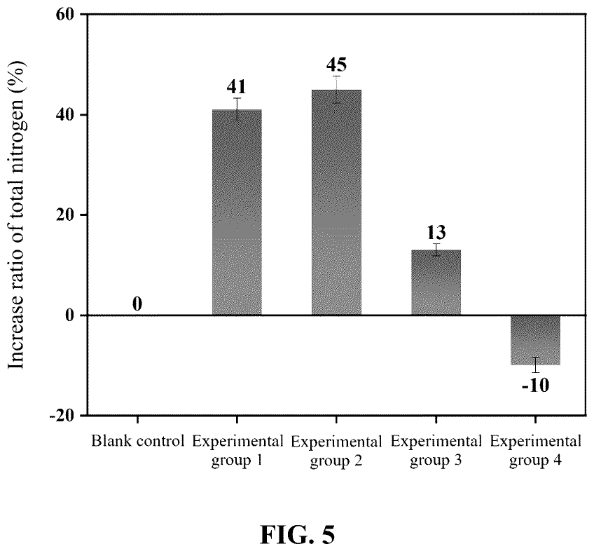

As can be seen from FIG. 4, compared with the blank control (conventional composting), the addition of magnesium modified biochar adsorbent waste could effectively reduce ammonia volatilization during the composting process. However, when the addition amount of magnesium modified biochar adsorbent waste exceeds 30%, the total ammonia volatilization flux increases rather than decreases, and the nitrogen immobilization efficiency also shows the same trend (as shown in FIG. 5). This may be because most of the carbon in the added magnesium modified biochar adsorbent waste is inorganic carbon, and in the case of keeping the total carbon to nitrogen ratio of the compost pile constant, the addition amount of straw is reduced, and the proportion of organic carbon is also reduced accordingly.

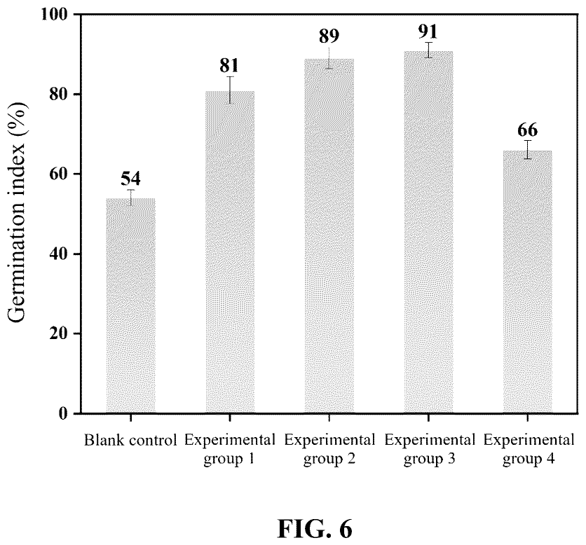

For microorganisms, the microbial carbon utilization efficiency is directly proportional to the content of organic carbon in the compost pile. Hence, when the addition amount of magnesium modified biochar adsorbent waste exceeds a certain proportion, the energy source required for the growth and reproduction of microorganisms is limited, the fermentation temperature rises slowly, and nitrogen is excessive and released in the form of ammonia, resulting in large loss of organic nitrogen. Based on these effects, the germination index also shows a trend of increase followed by decrease, as shown in FIG. 6. Therefore, the addition amount of magnesium modified biochar adsorbent waste in the range of 5-30% can reduce ammonia volatilization and immobilize nitrogen during the composting process, and can promote crop germination.

### Example 3

field at different nitrogen substitution ratios of chemical fertilizer on crop growth. The experimental plot area was 20 m², the rice density was 16,000 holes for 667 m², and the following steps were included.
This example investigated the effect of applying the composted fertilizer to the Step 1: The composted fertilizer of Experimental group 1 in Example 2 was taken and applied to the field as a basal fertilizer for the nitrogen substitution of chemical fertilizer at a ratio of 0%, 5%, 25% and 35%, respectively. Each treatment was replicated three times. The total input of nitrogen was 15 kg for 667 square meters, and the total input of phosphorus pentoxide and potassium oxide was 6 kg.
Step 2: 35%, 30% and 35% of the total amount of nitrogen application were respectively applied during the basal fertilizer stage, tillering fertilizer stage and panicle fertilizer stage.
Step 3: The rice was harvested after about 120 days. Before harvesting, rice panicles of about 10 m² plants were taken for each treatment, with three repetitions, and the actual yield of each treatment was determined.

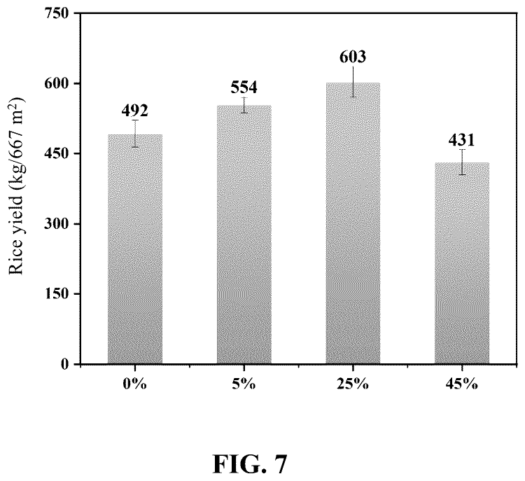

As can be seen from FIG. 7, compared with the application of pure chemical fertilizer, adding 5-25% of organic fertilizer conditioned by magnesium modified biochar adsorbent waste can effectively increase the yield of rice crops. However, when the addition amount of that organic fertilizer exceeds 25%, the rice yield decreases and is lower than that of pure fertilizer treatment. This may be because compared with the rapid release of nitrogen in chemical fertilizers and their susceptibility to runoff and leaching, the nitrogen nutrients immobilized by biochar in the added organic fertilizer are released more stably during the growth of rice, which is able to continuously provide sufficient nutrients for rice, thereby increasing the rice yield. However, when the substitution ratio of organic fertilizer is too large and more than 25%, rice cannot obtain nutrients rapidly during the basal fertilizer stage, and its slow growth and development trigger a chain reaction, resulting in a decrease in yield.

The present invention and the embodiments thereof are described above in an illustrative manner. This description is not restrictive, and the data used is just one of the implementations of the present invention. The actual data combination is not limited thereto. Therefore, if those of ordinary skill in the art are inspired thereby, without departing from the inventive concept of the present invention, the implementations and examples similar to this technical solution may be designed by those of ordinary skill in the art without creativity, and all shall fall within the scope of protection of the present invention.

What is claimed is:

1. A method for reducing ammonia volatilization and immobilizing nitrogen in a composting process using magnesium modified carbon-based phosphorus adsorbent waste, comprising:
introducing a magnesium modified carbon-based phosphorus adsorbent waste into a compost material for primary recycling, with a composting cycle of 20-60 days;
after the composting is completed, applying the magnesium modified carbon-based phosphorus adsorbent waste and the compost material to a field for secondary recycling, wherein the magnesium modified carbon-based phosphorus adsorbent waste and the compost material are applied to the field together in such a way as to equally replace chemical fertilizer nitrogen and phosphorus with organic manure nitrogen and phosphorus, the amount of that organic fertilizer applying to the field is 200-1000 kg for 667 m², and a substitution ratio of chemical nitrogen fertilizer does not exceed 50%;
the magnesium modified carbon-based phosphorus adsorbent waste is a magnesium modified biochar phosphorus adsorbent waste, which is obtained by placing magnesium modified biochar into a phosphorus-contaminated water after reaching adsorption saturation, wherein the biochar comprises carbon fibers, carbon nanotubes, carbon bricks, graphite, carbon aerogel, carbon spheres, or carbon foams; the magnesium element accounts for 10% of a total mass of the magnesium modified carbon-based phosphorus adsorbent;
an addition amount of the magnesium modified carbon-based phosphorus adsorbent waste accounts for 1-30% of a total dry weight of the compost material;
a total carbon to nitrogen ratio of the compost material is between 20:1 and 30:1.

2. The method for reducing ammonia volatilization and immobilizing nitrogen in a composting process using magnesium modified carbon-based phosphorus adsorbent waste according to claim 1, wherein before a start of composting or in an early stage of composting, or before a first compost pile turning, the magnesium modified carbon-based phosphorus adsorbent waste is introduced into the compost material.

3. The method for reducing ammonia volatilization and immobilizing nitrogen in a composting process using magnesium modified carbon-based phosphorus adsorbent waste according to claim 1, wherein the compost material is one or more of straw, weeds, edible fungus residue, food scraps, kitchen waste, sludge, bark, sawdust, chaff, plant ash, livestock and poultry manure, or animal hair, horns, hooves and bones.

4. The method for reducing ammonia volatilization and immobilizing nitrogen in a composting process using magnesium modified carbon-based phosphorus adsorbent waste according to claim 3, wherein the substitution ratio of chemical nitrogen fertilizer applied to the field is 5-25%.

5. The method for reducing ammonia volatilization and immobilizing nitrogen in a composting process using magnesium modified carbon-based phosphorus adsorbent waste according to claim 2, wherein the compost material is one or more of straw, weeds, edible fungus residue, food scraps, kitchen waste, sludge, bark, sawdust, chaff, plant ash, livestock and poultry manure, or animal hair, horns, hooves and bones.
